(19) United States
(12) Patent Application Publication
(10) Pub. No.: US 2005/0247814 A1
(43) Pub. Date: Nov. 10, 2005

(54) Belt retractor

(75) Inventors: Martin Prokscha, Schwaebisch Gmuend (DE); Michael Bolz, Welzheim (DE)

Correspondence Address: TAROLLI, SUNDHEIM, COVELL & TUMMINO L.L.P., 1111 LEADER BLDG., 526 SUPERIOR AVENUE, CLEVELAND, OH, 44114-1400, US

(73) Assignee: TRW Automotive GmbH

(21) Appl. No.: 11/120,239

(22) Filed: May 2, 2005

(30) Foreign Application Priority Data
May 7, 2004 (DE) 20 2004 007 307.2

(51) Int. Cl. B60R 22/34

(52) U.S. Cl. 242/390.8

(57) ABSTRACT

A belt retractor includes a belt spool and an electric motor (19) for adjusting the belt band withdrawal force. The electric motor is coupled to the belt spool by a gear. The gear includes a first gear part (18; 42) providing a limited free-running operation.

### BACKGROUND OF THE INVENTION

The invention relates to a belt retractor.

In order to fasten oneself in a vehicle, a withdrawal of belt band is necessary, which is wound up on a belt spool of a belt retractor. In belt retractors including a direct drive, an electric motor is provided, which is coupled to the belt spool by a gear. The term “gear” in this context is to be understood in a general sense, and designating a mechanical coupling of the electric motor to the belt spool; a reduction or step-up is not presupposed. Such a belt retractor may have a sensor arrangement with a rotation sensor. When an occupant pulls on the wound up belt band, the sensor arrangement detects the rotation of the belt spool and its direction. After this, the motor can provide a supporting torque in order to facilitate the withdrawal of belt band.

A disadvantage in such a belt retractor is that the support by the motor can not take place immediately. This is due to the fact that a rotation can only be detected after a particular minimum rotation angle is exceeded, the minimum rotation angle depending on the resolution of the rotary sensor. Therefore, when withdrawing the belt band, the occupant first of all experiences an unpleasant jerk owing to the increased force necessary in order to co-rotate the initially resting motor, before a motor-assisted belt band withdrawal takes place. This undesired effect can theoretically be reduced by high-resolution sensors; such sensors are, however, relatively expensive.

It is an object of the invention to provide a belt retractor which makes possible a jerk-free belt band withdrawal by simple means.

### BRIEF SUMMARY OF THE INVENTION

According to the invention, a belt retractor comprises a belt spool and with an electric motor for adjusting the belt band withdrawal force. The electric motor is coupled to the belt spool by a gear. The gear includes a first gear part providing a limited free-running operation. It is therefore not attempted to detect a rotation of the belt spool as early as possible. Rather, the invention allows an initial resistance-free rotation of the belt spool. This is possible because, owing to the free-running operation, the motor does not have to be co-rotated at first. This initial rotation phase can be utilized for detecting the rotation and its direction by a sensor arrangement. The free-running operation and the sensor arrangement can be coordinated with each other so that an assistance of the belt band withdrawal by the motor is already brought about before completion of the free-running operation. Thus the occupant does not experience a jerk on withdrawal of the belt band after completion of the free-running operation. Depending on the size of the free-running rotation angle, low-resolution and hence favourably-priced rotation sensors can be used. For the basic function, it is irrelevant which part of the gear provides the free-running operation; it is only important that it is arranged in the flux of force between the motor and the belt spool.

In order to fully utilize the free-running operation, preferably at least one spring element is provided, which pre-stresses the first gear part against its free-running direction. Thereby, it is also ensured that the free-running is only effective in the desired direction of rotation of the belt spool. Thus, when the motor is reversed, an immediate winding of the belt band on the belt spool is possible without previous free-running operation.

### DETAILED DESCRIPTION OF PREFERRED EMBODIMENTS

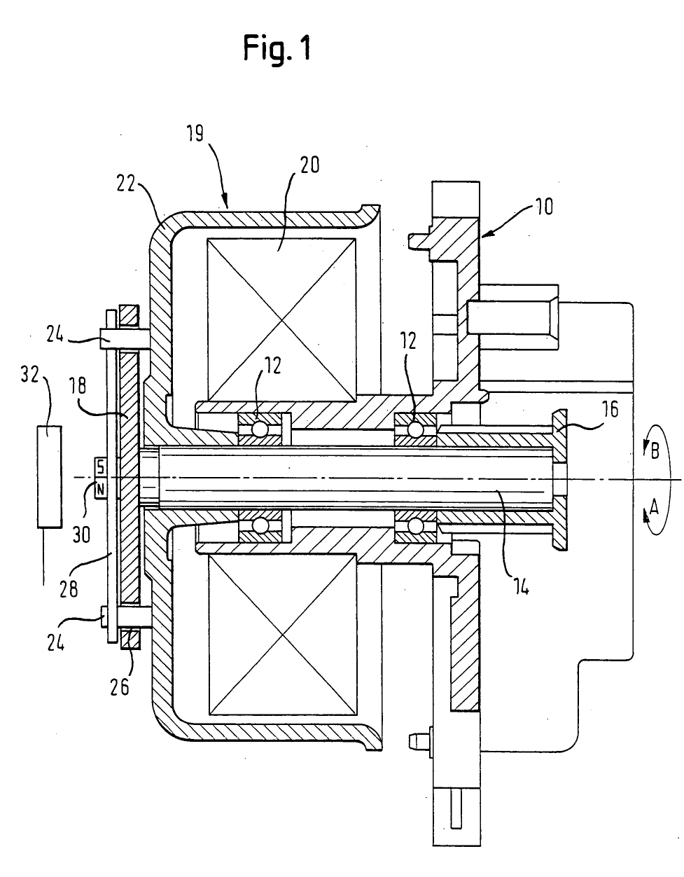

FIG. 1 shows a first embodiment of the belt retractor according to the invention in lateral sectional view;

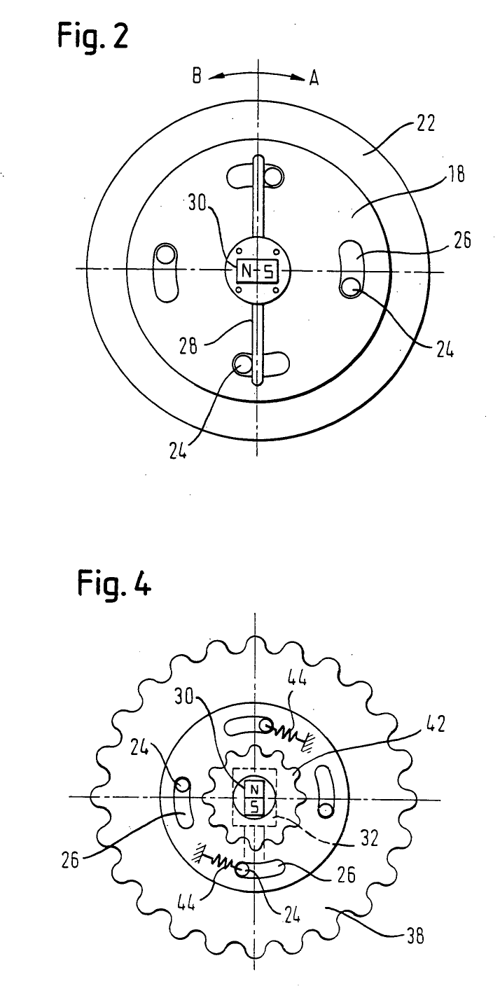

FIG. 2 shows a front view of the belt retractor of FIG. 1;

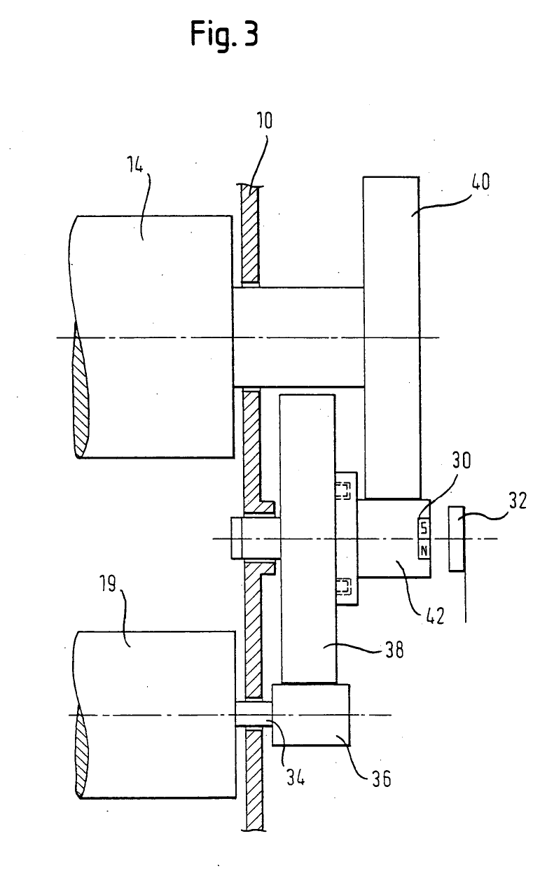

FIG. 3 shows a second embodiment of the belt retractor according to the invention in lateral sectional view; and

FIG. 4 shows a front view of a part of the belt retractor of FIG. 3.

The first embodiment of the belt retractor according to the invention, which is illustrated in FIG. 1, comprises a shaft 14 rotatably mounted by means of ball bearings 12 in a frame 10. On one end of the shaft 14 a drive pinion 16 is placed, which is coupled non-rotatably to a belt spool (not shown). Accordingly, through a rotation of the shaft 14 in a first rotation direction (unwinding direction A), belt band is unwound from the belt spool. Through rotation in an opposite second rotation direction (winding-up direction B), belt band is wound up. At the other end of the shaft 14, a disc 18 is fastened. The belt retractor further comprises an electric motor 19 which is formed from a stator 20 and a rotor 22. The stator 20 is arranged around the part of the frame 10 in which the shaft 14 is mounted. The rotor 22 is constructed as a rotatable motor bell.

Formed on the rotor 22 are several cams 24. The cams 24 engage in recesses 26 formed as slotted holes in the disc 18 (see also FIG. 2). The extent of the recesses 26 in peripheral direction is greater than that of the cams 24. The cams 24 are arranged in relation to the associated recesses 26 so that the disc 18 has play in peripheral direction with respect to the rotor 22. A spring element in the form of a plate spring 28 pre-stresses the disc 18 against the unwinding direction A.

Of course, the cams 24 can also be formed on the disc 18 and the recesses 26 can be formed on the rotor 22.

Thereby, a gear is formed between the electric motor 19 and the belt spool, with the disc 18 (after overcoming the pre-stressing force of the spring 28) providing a free-running operation in the unwinding direction A, which is defined by the extent of the recesses 26 in peripheral direction.

The belt retractor is additionally equipped with a sensor arrangement. On the disc 18 a permanent magnet 30 is arranged. Opposite the permanent magnet 30 a simple Hall sensor 32 or the like is located. By means of the sensor 32 a rotation of the disc 18 in the unwinding direction A is detected. This rotation, which corresponds to a rotation of the belt spool in the unwinding direction owing to the non-rotatable coupling, is detected before the free-running operation of the disc 18 is completed. Instead of the Hall sensor 32 and the permanent magnet 30, another suitable rotation sensor can also be used, which fulfils this function.

With a pulling on the wound-up belt band, the belt spool rotates in the unwinding direction A. Owing to the free-running operation, the disc 18 rotates without having to overcome the resistance moment of the resting motor 19. The sensor arrangement recognizes the rotation in the unwinding direction A already in the free-running phase, whereby immediately an assisting rotation of the motor 19 is brought about for a facilitated belt band withdrawal.

FIGS. 3 and 4 show a second embodiment of the belt retractor according to the invention, the same reference numbers being used as in the first embodiment for corresponding parts. On a drive shaft 34 of an electric motor 19, a drive wheel 36 is mounted. The drive wheel 36 drives a first intermediate wheel 38 mounted in a frame 10. The retractor shaft 14, likewise mounted in the frame 10, is coupled non-rotatably to the belt spool. At one end of the retractor shaft 14, a drive wheel 40 is fastened meshing with a second intermediate wheel 42.

The first and second intermediate wheels 38, 42, as in the first embodiment, have cams 24 and associated recesses 26 in the manner of a connecting link guide, in order to provide a limited free-running operation of the second intermediate wheel 42. On the second intermediate wheel 42, spring elements 44 are fastened (see FIG. 4), which engage on some of the cams 24 and thus pre-stress the second intermediate wheel 42 against its free-running direction.

A sensor arrangement is also provided for detecting a rotation of the belt spool in unwinding direction, e.g. with a permanent magnet 30 arranged on the second intermediate wheel 42 and with a Hall sensor 43 lying opposite. The mode of operation of this embodiment basically corresponds to that of the first embodiment.

1. A belt retractor, comprising a belt spool and an electric motor for adjusting the belt band withdrawal force, the electric motor being coupled to the belt spool by a gear, wherein the gear includes a first gear part providing a limited free-running operation.

2. The belt retractor according to claim 1, wherein at least one spring element is provided, which pre-stresses the first gear part against its free-running direction.

3. The belt retractor according to claim 1, wherein the first gear part is coupled non-rotatably to the belt spool.

4. The belt retractor according to claim 1, wherein the first gear part comprises a disc.

5. The belt retractor according to claim 4, wherein the disc is arranged on an internal shaft with respect to the motor.

6. The belt retractor according to claim 1, wherein the gear comprises a second gear part coupled non-rotatably to the motor, one of the first and second gear parts having at least one cam which engages into a recess formed on the other gear part, the extent of the recess in peripheral direction being greater than that of the cam.

7. The belt retractor according to claim 6, wherein the second gear part is a rotor of the electric motor.

8. The belt retractor according to claim 1, wherein the electric motor drives a first intermediate wheel, the first gear part comprising a second intermediate wheel meshing with a drive wheel coupled to the belt spool, one of the first and second intermediate wheels having at least one cam which engages into a recess formed in the other intermediate wheel, the extent of the recess in peripheral direction being greater than that of the cam.

9. The belt retractor according to claim 1, wherein a sensor arrangement is provided for detecting a rotation direction of the belt spool.

10. The belt retractor according to claim 9, wherein a permanent magnet is arranged on a component coupled non-rotatably to the belt spool.
